(19) United States
(12) Patent Application Publication
(10) Pub. No.: US 2008/0281683 A1
(43) Pub. Date: Nov. 13, 2008

(54) Business Marketing Process

(76) Inventor: Darin Thomas Hindmarsh, Queensland (AU)

Correspondence Address: Howard & Howard Attorneys P C, 39400 Woolward Avenue Suite 101, Bloomfield Hills, MI, 48304-5151, US

(21) Appl. No.: 11/662,715

(22) PCT Filed: Sep. 16, 2005
(86) PCT No.: PCT/AU05/01422

§ 371 Date: Mar. 19, 2008

(30) Foreign Application Priority Data
Sep. 16, 2004 (AU) 2004905324

(51) Int. Cl. G06Q 30/00

(52) U.S. Cl. 705/14

(57) ABSTRACT

A marketing method for a business is disclosed. The method comprises the steps of selecting at least one other business which may involve analysis of certain characteristics of the workforce of that business. The method further involves negotiating an agreement with the other business to locate within the premises of that other business a support member The support member includes printed indicia relating to goods and/or services of the first business. The support member also has a receptacle for business cards of a representative of the first method. The method further involves locating the support member in the premises of the other business and replacing promotional brochure and/or replenishing business at spaced time intervals. The support member may be located in a staff room, lunch room, waiting room or a restroom. The method preferably involves numerous re-visits to the other business and presentations to the staff and/or clients of the other business. The method may involve monitoring the results from the staff and/or clients of the other business and reporting them to the owner of the other business. Preferably, the method involves carrying out the above steps in a plurality of businesses.

### FIELD OF THE INVENTION

This invention is concerned with a process for marketing a business.

The invention is concerned particularly, although not exclusively with a process for marketing a business by creating a direct disclosure of marketing material to a potential customer in his or her work environment or at a business visited by a potential customer.

### BACKGROUND TO THE INVENTION

There are many methods of marketing services and products to potential customers. Typical marketing techniques employ one or more forms of media to communicate with potential customers and range from demographically targeted narrow audiences to mass marketing techniques.

Demographically targeted campaigns may comprise carefully timed advertisements on television and radio, perhaps on selected channels to avoid wastage of marketing costs to unlikely candidates. Similarly, print media marketing may employ special interest magazines or journals to focus a campaign on a preferred customer profile, while newspaper advertising may be conducted on selected days and in specific parts of the newspaper in an attempt to reach a target audience.

With marketing campaigns in mass media such as television, radio and print media, there exists a very high wastage rate in endeavouring to appeal to a general market in the midst of many other often competing marketing campaigns. Moreover, the cost of generalized mass marketing campaigns in conventional media is extremely high. As they require both frequency and duration to be effective, it is often beyond the means of small to medium business enterprises to employ these strategies.

Less expensive marketing campaigns such as letterbox drops or journal inserts of flyers and brochures are generally regarded to be effective only over sustained periods of time and thus eventually even these forms of marketing ultimately can be prohibitively expensive to small businesses.

Advertising and marketing organizations are continually developing targeted marketing systems which they claim, whilst expensive, are so highly targeted that the low wastage rate makes these techniques cost effective. In order to demonstrate the effectiveness of marketing techniques, these organizations have developed procedures to measure effective exposures to potential customers to the extent that differing marketing techniques now attract a direct cash value per exposure. On a statistical response basis, television may attract, for example, $0.03 per exposure cash value whereas print media may attract a $0.01 per exposure. More specialised techniques such as billboards and mobile automotive advertising may attract rates of $0.05 per exposure or even higher. Although there is considerable speculation in any such valuation, the above figures serve to illustrate the point that targeting of potential customers can be more cost effective. While these marketing techniques may be more effective, again, the cost is out of reach for most small business owners who ultimately tend to rely on the Yellow Pages™ telephone directory as their sole marketing mechanism.

While it may be possible through friends or business colleagues to have promotional brochures distributed to other businesses, typically this involves pinning an inexpensive monocolour printed flyer or the like to a notice board or placing a small quantity of brochures on a table or bench in a lunch room or similar location. Because such brochures are unattractive and are easily damaged when pinned to a notice board or lying in a pile on a table, their effective life is often only several days. In the absence of frequent replacement and an adequate number of display sites, it is virtually impossible to systematize this form of marketing. Many notice boards become clogged with out of date and irrelevant material due to a lack of attention and interest by management.

In contrast an effective form of marketing having a very high exposure value is known as “Table Top”™ advertising where specially constructed tables are leased to restaurants or other public venues and replaceable advertising indicia is located under a clear protective surface on the table top. This type of advertising, like bus shelter advertising, is known to have a high exposure value as people tend to read and notice advertising messages when they are waiting for table service, a bus or the like when otherwise they would not assimilate that message in a dynamic passing situation.

While generally effective for its intended purpose, such Table Top or bus shelter advertising is less effective than it might otherwise be as, if a reader is interested in the product or service offered, they are generally only provided with a telephone number to contact and the reader must write down that number for later recall otherwise the effect of the advertising opportunity is wasted. Even then, to many people, the requirement to call an impersonal telephone number for further information can be daunting.

Advertising effectiveness has been in a slow decline due, at least in part, to the fact that consumers are becoming more aware of subliminal messages used by the advertising profession. It has been estimated that a consumer may be bombarded by up to 10,000 advertising message per day. Each consumer must “block out” a majority of these messages either consciously or unconsciously. Sales systems involving relationship-based advertising use a method which relies on one person referring another person to a third party who they believe can either help fulfill some need or is an expert in their field.

Although this is one of the most effective and enduring forms of advertising and subsequent relationship building, it can be very difficult to identify, firstly, the referring party and, secondly, the party who is the ultimate consumer of the goods and services.

It is known to provide information to employees in their work place, other than simply related to their daily tasks. This information is usually in relation to policy and procedure while at work. It is known to also provide information at ad hoc seminars in relation to other matters, such as legislative changes to superannuation or tax law. There is, however, no detailed and systematic approach to targeting a work force as potential clients and setting in chain a series of steps to build a relationship.

Accordingly there is a need for a cost effective marketing technique for the services and/or products of businesses, particularly small businesses.

### SUMMARY OF THE INVENTION

According to one aspect of the invention there is provided a marketing method for businesses, the method comprising the steps of:

negotiating an agreement with another business to locate within the premises of the other business a support member for printed indicia relating to the goods and/or services of a first business, the support member including a protective cover to receivably locate a promotional brochure and a receptacle for business cards of a representative of the first business; and,

replacing the promotional brochure and replenishing the business cards at spaced intervals, preferably regular.

The method preferably includes the step of conducting a presentation to one or more staff members or clients of the other business, the presentation relating to the goods and services of the first business as promoted through the support member. Conducting the presentation may be performed by the representative.

Preferably the method includes the step of conducting two or more presentations, each spaced from the other in time. The presentations may be regularly spaced, such as weekly, fortnightly, monthly or three monthly or any suitable time spacing.

The method may include the step of locating the support member in a location in which staff members congregate such as a staff room or lunch room. Alternatively, the support member may be located in a public waiting room or a rest room.

The method preferably extends to negotiating with a number of businesses as described above.

Suitably, the support member comprises a compact frame having a transparent cover for printed indicia located therebehind.

If required, the transparent cover may be hingedly connected to the frame.

Alternatively, the transparent cover may be resiliently connected to the frame.

Preferably, the transparent cover comprises a clear plastics sheet integrally formed along one edge thereof with an adjacent edge of the frame.

The frame may include a support base for support on a horizontal surface.

Alternatively, the frame may include a mounting means adapted, in use, to support the frame from a vertical surface.

Suitably, the support member includes a receptacle to receivably locate business cards.

Preferably, the receptacle includes a transparent window through which to view information printed on the business cards.

If required, the receptacle may include a protective closure member movable between a normally closed position and an open position for access to the business cards.

If required, the support member may include a further receptacle for business cards or notes from persons wishing to obtain further information from the first business owner.

Suitably, the promotional brochure is replaced and/or the business cards are replenished on a monthly basis.

If required, the promotional brochure is replaced and/or the business cards are replenished on a fortnightly basis.

Preferably, the promotional brochure is replaced and/or the business cards are replenished on a weekly basis.

Replacing or replenishing the printed indicia may be carried out by the representative or another party. The representative may be an owner of the first business or one or more persons engaged by the owner of the first business.

Preferably, the one or more persons engaged by the first business owner are selected from suppliers of goods and/or services other than those of the first business, who regularly visit the other businesses.

Suitably, business cards or notes of enquirers are collected on a regular basis and returned to the first business owner.

Preferably, the support member is located in a public waiting area or staff room of the other businesses.

The support member may be located in a lunch room or rest room of the other businesses.

According to a further aspect of the invention there is provided a support member for printed indicia for use in accordance with the marketing of goods and services to other business, the support member comprising:

a transparent protective cover to receivably locate a promotional brochure of a first business; and,

a receptacle for business cards of a representative for the first business.

Suitably, the support member comprises a compact frame having a transparent cover for printed indicia located therebehind.

If required, the transparent cover may be hingedly connected to the frame.

Alternatively, the transparent cover may be resiliently connected to the frame.

Preferably, the transparent cover comprises a clear plastics sheet integrally formed along one edge thereof with an adjacent edge of the frame.

The frame may include a support base for support on a horizontal surface.

Alternatively, the frame may include a mounting means adapted, in use, to support the frame from a vertical surface.

Suitably, the support member includes a receptacle to receivably locate business cards.

Preferably, the receptacle includes a transparent window through which to view information printed on the business cards.

If required, the receptacle may include a protective closure member movable between a normally closed position and an open position for access to the business cards.

If required, the support member may include a further receptacle for business cards or notes from persons wishing to obtain further information from the first business owner.

If required, the support member may include a telecommunications device preset to communicate with the first business upon actuation by an enquirer.

### BRIEF DESCRIPTION OF THE DRAWINGS

In order that the various aspects of the invention may be more fully understood and put into practical effect, reference will now be made to a preferred embodiment illustrated in the accompanying drawings in which:

FIG. 1 shows a cross-sectional side elevation of a support member;

FIG. 2 shows a front perspective view of the support member of FIG. 1;

FIG. 3 shows a schematic representation of the preferred steps in a method of the present invention.

### DETAILED DESCRIPTION OF THE DRAWINGS

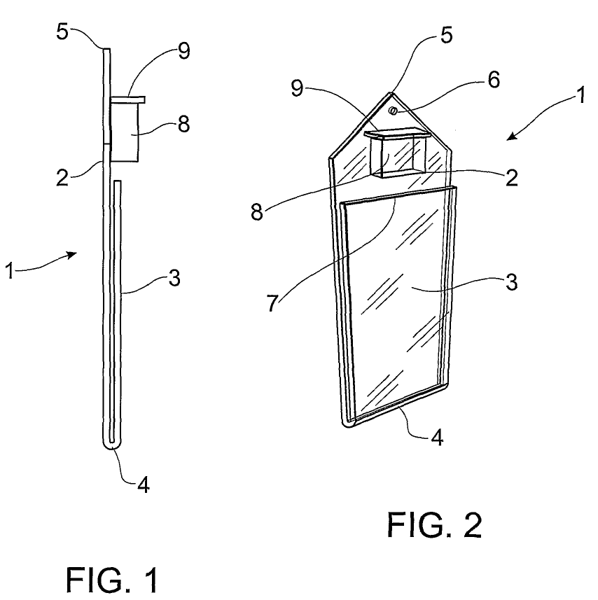

As shown in FIGS. 1 and 2, the support member 1 according to a further aspect of the invention comprises a sheet of clear acrylic polymer folded intermediate its ends to form a frame 2 and a front protective cover member 3 joined along a lower edge 4.

The frame 2 is longer than cover member 3 and includes adjacent an upper end 5, a mounting aperture 6 to facilitate mounting on a vertical surface such as a wall by means of a fastener or hook (not shown).

Located on frame 2 between upper end 5 thereof and an upper edge 7 of cover member 3 is a box-like receptacle 8, also of clear acrylic sheet having a hinged lid 9 connected thereto. Receptacle 8 is adapted to receivably locate a supply of business cards.

In an alternative embodiment (not shown) the support member may comprise a mounting base to enable the support member to rest on a horizontal surface.

In use, a first business owner negotiates with one or more other business owners to locate the device of FIGS. 1 and 2 in an area accessible to employees and/or visitors to the premises of the other business owners. The terms of the negotiation may be any suitable terms mutually acceptable to the first and other business owners and may include such terms as a nominal monthly rental fee, a commission based on a percentage of sales identified as originating from a particular business premise or some other reward or inducement system. The other business owners may see advantage to their staff or visitors in offering the services or goods of the first business and may choose to waive any fee.

Once agreed, the first business owner places or authorises the placement in a waiting room, on a service counter or in a lunch or rest room of the other business, the marketing device 1 described herein or similar. The marketing device may include an A4 sized brochure located between the frame 2 and protective cover 3 by flexing cover 3 outwardly. For a free standing device, two brochures placed back to back may be employed to be visible from both sides of the marketing device 1. A supply of business cards is located in receptacle 8 for easy access by interested persons. Interested parties may insert their own business cards or written notes into the receptacle or, in another embodiment, into separate receptacle.

Whilst waiting for attention in a waiting room or at a service counter, a customer of the other business owner will notice the marketing brochure and whether interested in the marketing message or not, will assimilate at least part of the marketing message as they may not be distracted by other thoughts at the time. If, having at least partially assimilated the marketing message, the customer is sufficiently interested to pursue further enquiries, the business card forms a convenient and compact source of contact information to make a contact with the business of the first business owner. To avoid the negativity of having to contact an unknown person at a telephone number provided on the business card, the name of a sales or technical representative is supplied to enable a less impersonal contact with a greater degree of self-confidence in the caller as they feel they already partly know the representative, if only by name.

Although the first business owner, for example a fast food provider, may limit the spread of advertising devices to a convenient radius around his fast food outlet, a fast food chain would not be so limited and would capitalize on a spontaneous response of the other business owner's visitor or customer. For more broad ranging or generic services such as mortgage brokers, financial advisors, accountants, lawyers and the like, there is no real geographic limitation other than the town, city or region in which the services are offered.

Similarly in the other business owner's premises, in say a lunch room or rest room, employees are exposed to the marketing message usually at a time when there is little or no other mental distraction whereby the marketing message attracts a level of attention and assimilation that otherwise would not be possible. The convenience and personal touch of a business card for later enquiries makes it less likely that an idle enquiry might be overlooked or foregone.

By refreshing the advertising indicia on a regular basis, regular visitors to another business owner's premises and employees have the advertising message reinforced with a great frequency. The level of interest shown can be monitored both by actual enquiries made or the rate of replenishment of business cards.

Where it is possible for the first business owner to make regular visits to other business owners to replace advertising indicia and to replenish business cards, such an opportunity is useful in cementing relationships between the first and other business owners.

Alternatively, the first business owner can utilize full or part-time employees to replace/replenish advertising indicia or, where a plurality of marketing devices of differing first business owners are spread throughout a city, an agency may be employed to handle the replacement/replenishment process.

There already exist a number of suppliers of goods such as stationery and the like who make regular weekly or fortnightly visits to customers to replenish supplies of stationery or other goods to a standing order. Such persons, for reward, could be employed to handle the replacement/replenishment process as the process is very swift, taking less than a minute to achieve. In the preferred embodiments, however, emphasis is given to building a relationship with potential customers and to those people who become customers.

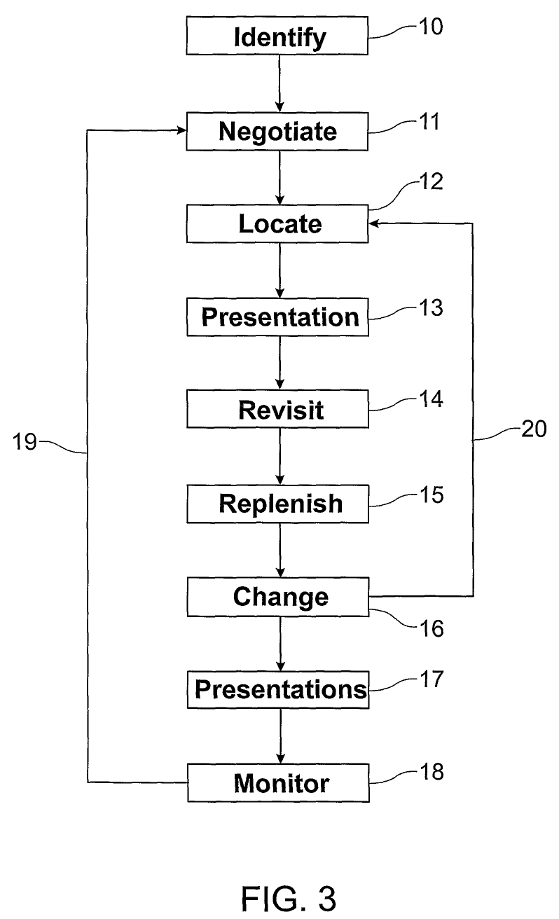

Referring to FIG. 3, there is seen a schematic outline of a preferred embodiment of the method of the present invention.

The first step may be to identify 10 the potential targets in other businesses. This step may involve researching and investigating the nature of the other business's commercial activities and the make-up and distribution of the members of the staff and/or the client base. Depending on the access to information, this may provide a very effective means of close targeting of the audience. For example, if the selected workplace is a work site, information on services and goods may be targeted to labourers, trades persons, contractors and the self-employed. These goods may relate to tools of trade, professional and support organisations and recreational pursuits that may be shown to be more common in this group. The services may also extend to other beneficial items like financial consultancy services, investment advice, superannuation advice and similar. These later services would clearly be relevant to a wide range of workers and clients in society. Identifying the preferred site or sites may involve a business specific inquiry or a business sector specific inquiry.

The next step in the method is negotiating 11 an agreement between the owner of the first business and the owner or owners of the other business or businesses. The terms of any such agreement may be whatever is considered suitable and acceptable to the parties. In one application, the first business owner may pay a fee for working the present invention on the premises of the other businesses. That fee may be a flat fee or may be calculated on the value of business written out of the site. Other innovative methods of calculating the return to the owners of the other businesses may be used. The agreement may extend to matters such as rights of entry, frequency of visits, type of material that may be disclosed and any privacy considerations that must be addressed.

Once negotiations have been successfully concluded, the owner of the first business or his or her agent may then locate 12 a support member in the selected location of the other business. That location may be anywhere suitable. It is envisaged that preferred locations would be lunch rooms, staff rooms or training rooms where staff members are known to congregate. Other suitable venues may be waiting rooms for clients and even restrooms. 10 In the preferred embodiment, a representative of the first business delivers a presentation 13 to the target audience at the premises of the other business. The presentation may be in the form of a seminar on the services or goods that are being offered. The presentation may be oral or audio-visual or any suitable style. It is preferred that presentation be relatively short and informative. The presentation may also introduce the system and characteristics of the support member and its intended use. Once the initial presentation is concluded, the first business owner or their agent may schedule a revisit 14. Preferably, a series of regular revisits may be scheduled and conducted. The revisits may be at any suitable interval such as one week, two weeks, monthly, quarterly or annually. Other periods may, of course, be appropriate. The importance of the revisits is considerable in that it provides an on-going point of contact which increases the chance of forming a lasting relationship with potential customers and those who become customers.

During one or more of the visits, advertising indicia may be replenished 14 and business cards brought up to date. The first business owner may check for any notes or queries received in the embodiment featuring a support member having a receptacle for such items. If an agent such as a stationer is acting for the first business owner, he or she may transfer the material back to the first business for actioning.

The first business owner may choose to change 16 the material to broaden the range of goods or services offered or to bring it up to date. The location may also be changed 20. This also serves the added advantage of avoiding staleness of the material which would allow it to simply fade into the background for the staff members or others. Repeat presentations 17 are highly valued as they create and maintain a personal contact relationship between the first business and the targeted audience.

The first business owner may conveniently monitor 18 the productivity of an individual site and establish data such as number of enquiries, number of cards taken, number of concluded contracts and effects of any changes. This will better allow the business owner to use the strategies that are most effective in this environment. The business owner may indeed decide that the site is uneconomic and choose to close it down.

The results may be conveyed 19 back to the owner of the other business. This may see the recommencement of negotiations to vary the agreement.

The above outline sets out a method for effective targeting in a workplace of the staff as potential customers to a third party outside the employer/employee relationship. This targeted audience may also include the clients of the second business. The present method benefits from the multiple relationships created, including with the owners of the other businesses and their staff. It is envisaged that the owners of the other businesses would derive considerable benefit from the services and/or goods provided to them and their staff or clients.

The use of “mini-seminars” could be very effective in raising awareness of the first business and its goods or services. Further, creating acquaintanceships would then to lead to potential clients contacting the first business when they are interested in the product or service or even for general enquiries.

The present method allows the insertion of marketing brochures tailored to a business in which the device is displayed. Mini-seminars may be crafted to augment the advertising material to provide a full outline of activities of the first business.

A coffee and tea room or other facility or restroom for staff in virtually all workplaces is a fact that has not been harnessed effectively for business promotion. The support member or display device of the present invention allows for a regular exchange of forms of information which may be two-way.

An important aspect of this method of advertising is the regular “person-to-person” contact that occurs with the staff of the organisation or their clients, which allows a relationship to develop between the representative of the first business tending to the display device and the staff members of the organisation in which the device is displayed. This encourages and promotes acceptance by staff members of the owner or his or her representative as an “expert” and person they know.

The support member needs to be robust, clean and have the ability to be changed regularly to keep it up to date and maintain its appearance.

With the system of the present invention in place with associated presentations to staff or clients, together with regular changes of material displayed in the support member, the relationship may be promoted to procure services on an on-going basis at a far cheaper cost than advertising strategies such as television, newspapers and radio. The present invention allows a relationship that may be leveraged with associates or staff in a manner which is not achieved through direct advertising.

Targeting may include providing advertising indicia that suit and are tailored to the business demographic, socioeconomic level, educational level, needs and even prejudices of the staff members (eg., a specific sporting team area).

It will readily be apparent to a person skilled in the art that many modifications and variations may be made to the various aspects of the invention without departing from the spirit and scope thereof.

For example, the marketing device could include an additional receptacle to receive business cards or notes from enquirers. These enquirer business cards and/or notes could be collected and responded to when the replenishment/replacement process is being performed.

An easy and relatively inexpensive means to encourage enquiries could be to place the merchandising device adjacent a telephone. Alternatively, the device could include a captively held cell phone programmed to dial the representative's telephone number just by pushing a singly accessible keypad button.

The above detailed description provides preferred exemplary embodiments only, and is not intended to limit the scope, applicability, or configuration of the present invention. Rather, the detailed description of the preferred exemplary embodiments provides those skilled in the art with an enabling description for implementing the preferred exemplary embodiments of the invention. It should be understood that various changes can be made in the function and arrangement of elements and steps without departing from the spirit and scope of the invention.

1. A marketing method for a business, the method comprising the steps of:
selecting at least one other business;
negotiating an agreement with the other business to locate within the premises of the other business a support member for printed indicia relating to the goods and/or services of a first business, the support member including a protective cover to receivably locate a promotional brochure and a receptacle for business cards of a representative of the first business;
locating the support member in the premises of the other business; and
replacing the promotional brochure and/or replenishing business cards at spaced time intervals.

2. The method of claim 1 wherein:
selecting the other business includes the step of assessing the nature of the employees and/or clients of the other business and assessing the likelihood of their interest in the goods or services of the first business.

3. The method of claim 1 wherein:
locating the support member includes the step of locating the support member in one or more of a staff room, a lunch room, a waiting room and a restroom.

4. The method of claim 1 further comprising the step of:
delivering a presentation to staff members and/or clients of the other business, the presentation relating to the goods and/or services of the first business.

5. The method of claim 4 further comprising the step of revisiting the other business and delivering the presentation to the staff and/or clients on at least one subsequent occasion.

6. The method of claim 1 further comprising the step of changing the promotional brochure at regular intervals.

7. The method of claim 1 further comprising the step of monitoring the response from the staff and/or clients of the other business.

8. The method of claim 7 further comprising the step of reporting the results of monitoring the response to the owner of the other business.

9. The method of claim 1 wherein the support member includes a transparent cover and receptacle for business cards of a representative of the first business.

10. The method of claim 9 wherein the support member further includes a compact frame having a transparent cover for printed indicia located therebehind.

11. The method of claim 10 wherein the support member includes a transparent cover comprising a clear plastic sheet integrally formed along one edge thereof with an adjacent edge of the frame.

12. The method of claim 11 wherein the receptacle includes a transparent window through which information printed on the business cards may be viewed.

13. The method of claim 12 wherein the support member includes a further receptacle for business cards or notes from persons wishing to obtain further information from the owner of the first business.

14. The method of claim 13 further including a telecommunications device pre-set to communicate with the first business upon actuation by an enquirer.
